(19) United States
(12) Patent Application Publication
(10) Pub. No.: US 2006/0201470 A1
(43) Pub. Date: Sep. 14, 2006

(54) Engine component having a honeycomb structure

(75) Inventor: Kevin Vichinsky, Portage, MI (US)

Correspondence Address: CROWELL & MORING LLP;INTELLECTUAL PROPERTY GROUP, P.O. BOX 14300, WASHINGTON, DC, 20044-4300, US

(73) Assignee: Mann & Hummel GmbH, Ludwigsburg (DE)

(21) Appl. No.: 11/370,840

(22) Filed: Mar. 9, 2006

Related U.S. Application Data
(60) Provisional application No. 60/660,097, filed on Mar. 10, 2005.

(51) Int. Cl. F02M 35/10; F02B 77/00

(52) U.S. Cl. 123/184.61; 123/195 C

(57) ABSTRACT

A component of a reciprocating internal combustion engine system includes first, second, and third layers. The third layer has a honeycomb structure and is disposed between the first and second layers.

### FIELD OF THE INVENTION

The present invention relates to a reciprocating internal combustion engine component that has a honeycomb structure.

### BACKGROUND OF THE INVENTION

It is highly desirable to reduce the noise and vibration generated by a motor vehicle, in particular by a passenger car. In a motor vehicle with an internal combustion engine, the engine system, including the reciprocating internal combustion engine and its accessory parts, is a major source of vibration and noise. A portion of the noise and vibration generated by the reciprocating internal combustion engine system is transmitted through the components of the engine system to the ambient environment and to the other components of the vehicle. The rest of the generated noise and vibration is absorbed by the components of the engine system.

It has been known in the past to wrap some jet aircraft engine components in with a covering having a cellular structure to reduce noise. Such coverings, however, have not been considered applicable to reciprocating internal combustion engines of motor vehicles.

### SUMMARY OF THE INVENTION

How much of the generated noise and vibration is transmitted (or absorbed) by a component of the engine system depends to a large extent on the material and configuration of the component. Applicant noticed that a thin plate-like component, such as a cover or a thin wall of an engine manifold, cannot absorb much vibration and noise. Applicant also noticed that, since a thin plate-like component generally does not have much damping and its natural frequencies are within the frequency range of the generated vibration and noise, it can be easily excited at its natural frequencies. As a result, the noise and vibration is actually amplified by the component.

Applicant discovered that when a thin plate-like component of an engine system is reinforced with a honeycomb structure, the amount of vibration and noise transmitted through the component can be significantly reduced. In particular, the air trapped in the honeycomb structure functions as a noise insulator, resulting in a significant reduction in the amount of noise transmitted through the component. Additionally, the component can no longer be excited at its natural frequencies to amplify the vibration and noise because its natural frequencies have been moved outside of the frequency range of the generated vibration and noise. Further, the stiffness of the component can be increased without a corresponding increase in material or weight. The term “honeycomb structure” is a known and well-understood term in structural engineering which refers to a structure formed with hollow, thin-walled cells or cavities, especially hexagonal cells. The cells or cavities of the honeycomb structure of the invention are preferably generally hexagonal, but need not be strictly so, and other hollow cellular configurations can be envisioned within the scope of the invention, e.g., diamond-shaped cells.

According to one aspect of the invention, a component of an reciprocating internal combustion engine system includes two layers and a honeycomb layer disposed between the two layers. Preferably, the component of the engine system has a thin plate-like configuration, and the two layers are attached to the honeycomb structure with adhesive or with fasteners, or are welded to the honeycomb structure. The component of the engine system may be a manifold, such as an intake manifold, or a wall of a manifold. The component may also be a cover, such as an acoustic cover or a valve cover.

### BRIEF DESCRIPTION OF THE DRAWINGS

The invention will be described in further detail hereinafter with reference to illustrative preferred embodiments shown in the accompanying drawing figures in which:

FIG. 1 is a perspective view of an engine's intake manifold, the wall of which includes a honeycomb structure.

FIG. 2 is a perspective view of an engine cover, which includes a honeycomb structure.

### DETAILED DESCRIPTION OF PREFERRED EMBODIMENTS

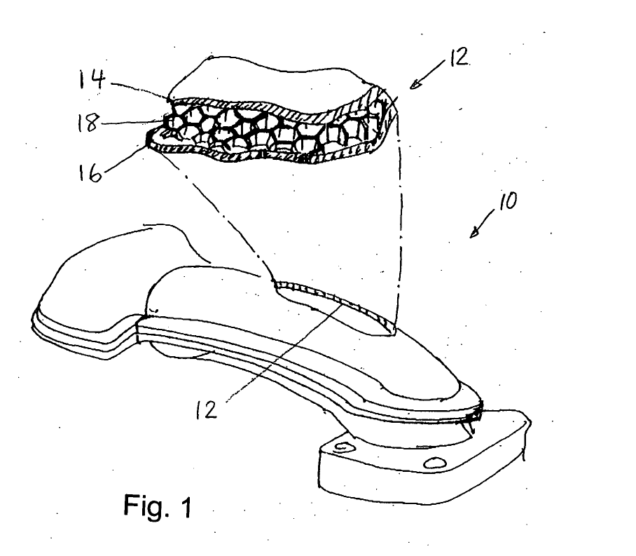

FIG. 1 illustrates a component 10 of a reciprocating internal combustion engine system (not shown in further detail), which in this case is an engine intake manifold. The intake manifold 10 has a wall 12 that includes an outer layer 14, an inner layer 16, and another layer 18 disposed between the outer and inner layers 14, 16.

Although the wall 12 of the manifold 10 shown in FIG. 1 is an exterior wall, it may be an interior wall. Each of the layers 14, 16, 18 may be made from any suitable material. For example, each layer 14, 16, 18 can be made from a metallic, plastic or composite material. Examples of suitable materials include metals such as aluminum, synthetic resins such as polyamide (nylon), polystyrene and/or acrylic resins, and well known composite materials such as carbon fiber composites.

The honeycomb layer 18 preferably is attached to the inner and outer layers 14, 16 and may be attached to the inner and outer layers 14, 16 in any suitable manner. For example, the honeycomb layer 18 may be glued, fastened, or welded to and between the inner and outer layers 14, 16.

A particularly preferred technique for attaching the first and second or outer layers to the third or inner layer is overmolding in which the first and second layers are formed of, for example, synthetic resin material by molding them around a core of honeycomb material. It is especially preferred to use a two-stage molding technique in which the honeycomb core is formed in a first stage and then the outer layers are formed in a second stage by molding them around the core.

The component may have the three-layer structure at any portion of the component where it may be used to reduce vibration and noise. In the embodiment shown in FIG. 1, for example, the entire wall 12 of the manifold 10 may be made from the three-layer structure, or only a portion of the manifold's wall 12 may be made from the three-layer structure.

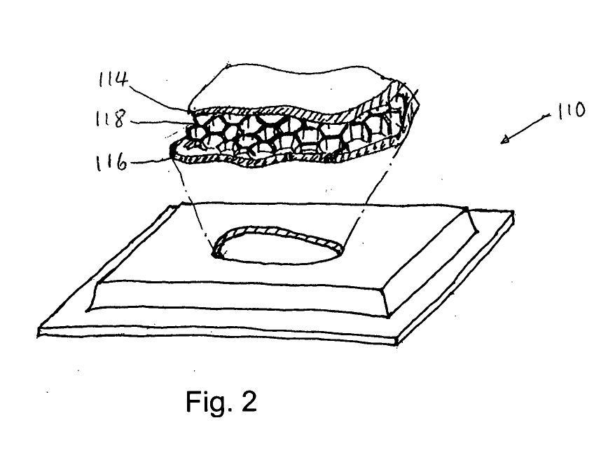

FIG. 2 illustrates another component 110 of an engine system, which in this case is a cover, such as an acoustic cover, a valve cover or any other cover. The cover 110 includes an outer layer 114, an inner layer 116, and another layer 118 disposed between the outer and inner layers 114, 116. Each of the layers 114, 116, 118 may be made from any suitable material. For example, each layer 114, 116, 118 can be made from a metallic, synthetic resin (i.e., plastic) or composite material.

The honeycomb layer 118 preferably is attached to the inner and outer layers 114, 116 and may be attached to the inner and outer layers 114, 116 in any suitable manner. For example, the honeycomb layer 118 may be glued, fastened, or welded to and between the inner and outer layers 114, 116.

The cover 110 may have the three-layer structure at any portion of the cover where it may be used to reduce vibration and noise. For example, the entire cover may be made from the three-layer structure, or only a portion of the cover may be made from the three-layer structure.

Although the components illustrated in FIGS. 1 and 2 are a manifold and a cover, the component of the present invention may be any component of the engine system which transmits vibration and noise or may be used to reduce vibration and noise.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A component of a reciprocating internal combustion engine system comprising a first layer, a second layer, and a third layer having a honeycomb structure, wherein the third layer is disposed between the first and second layers.

2. A component according to claim 1, wherein the first and second layers are attached to the third layer.

3. A component according to claim 2, wherein the first and second layers are attached to the third layer with adhesive.

4. A component according to claim 2, wherein the first and second layers are attached to the third layer with a fastener.

5. A component according to claim 2, wherein the first and second layers are welded to the third layer.

6. A component according to claim 2, wherein the first and second layers are overmolded around the third layer.

7. A component according to claim 1, wherein the component is an engine manifold.

8. A component according to claim 1, wherein the component is an engine cover.

9. A reciprocating internal combustion engine system comprising a component according to claim 1.

10. A reciprocating internal combustion engine system comprising a component according to claim 2.

11. A wall of a component of a reciprocating internal combustion engine system, comprising a first layer, a second layer, and a third layer having a honeycomb structure, wherein the third layer is disposed between the first and second layers.

12. A wall according to claim 11, wherein the first and second layers are attached to the third layer.

13. A wall according to claim 12, wherein the first and second layers are attached to the third layer with adhesive.

14. A wall according to claim 12, wherein the first and second layers are attached to the third layer with a fastener.

15. A wall according to claim 12, wherein the first and second layers are welded to the third layer.

16. A wall according to claim 12, wherein the first and second layers are overmolded around the third layer.

17. A component of a reciprocating internal combustion engine system comprising the wall of claim 11.

18. A component according to claim 17, wherein the component is an engine manifold.

19. A component according to claim 17, wherein the component is an engine cover.
